(19) United States
(12) Patent Application Publication
(10) Pub. No.: US 2025/0299432 A1
(43) Pub. Date: Sep. 25, 2025

(54) LOCAL SHADER ENGINE GEOMETRY AND ATTRIBUTE SHADING

(71) Applicant: ADVANCED MICRO DEVICES, INC., Santa Clara, CA (US)

(72) Inventor: Christopher J. Brennan, Boxborough, MA (US)

(21) Appl. No.: 18/615,035

(22) Filed: Mar. 25, 2024

(51) Int. Cl. G06T 15/40; G06T 1/20; G06T 15/00; G06T 17/10

(52) U.S. Cl. CPC G06T 15/40; G06T 1/20; G06T 15/005; G06T 17/10

(57) ABSTRACT

Systems and techniques are provided for deferred attribute shading operations in a graphics pipeline. A set of primitives is received by one or more shader engines of a processing core for rendering at least a portion of a scene. The shader engine(s) cull the received set of primitives by identifying a subset of the primitives that are potentially visible in the scene; generate intermediate data for the identified subset of primitives; generate attribute data values based on the intermediate data for the identified subset of primitives; and rasterize the identified subset of primitives for rendering based on the generated attribute data values.

### BACKGROUND

In a graphics processing system, three-dimensional (3D) scenes are typically rendered by graphics processing units (GPUs) for display on two-dimensional displays. To render such scenes, a GPU receives a command stream from an application indicating various graphical primitives (also referred to herein as primitives for brevity) to be rendered. The GPU then renders these primitives according to a graphics pipeline that has various stages, each including instructions to be performed by the GPU. The GPU typically calculates visibility information for all primitives in a visibility pass; in certain scenarios, it then splits the output of the visibility pass into tiles or other screen-space partitions. Based on the visibility data, the GPU generates and compresses data that is later used to render the primitives for the scene. In this manner, the GPU renders the visible primitives based on the compressed data. The graphics processing system then displays the rendered primitives as part of a three-dimensional scene displayed in a two-dimensional display.

Traditional rendering techniques often struggle to keep pace with the computational and memory bandwidth requirements posed by modern applications with respect to efficient processing, storage, and manipulation of geometry and attributes data-all of which are involved in generating the visual complexity and realism expected in modern graphical content. The management of geometry (such as vertices and primitives) and their associated attributes (such as color, texture coordinates, and normals) is a significant bottleneck.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system configured to implement deferred attribute shading operations in a graphics pipeline, in accordance with some embodiments.

FIG. 2 is a block diagram of processor cores configured to implement at least a portion of a graphics pipeline to perform deferred attribute shading operations, in accordance with embodiments.

FIG. 3 is a block diagram of an example processor core that comprises shader engines configured to implement deferred attribute shading operations, in accordance with embodiments.

FIG. 4 depicts a flow diagram for an operational routine of one or more shader engines implementing deferred attribute shading operations, in accordance with some embodiments.

### DETAILED DESCRIPTION

In conventional graphics pipelines, a vertex shader serves as a singular processing stage in which the attributes of vertices (such as their position, color, and texture coordinates) are calculated. The vertex shader performs transformations on vertex data to prepare those vertices for the next pipeline stages, typically including tasks like transforming vertex positions to screen space, lighting calculations, and projecting textures onto geometry. The vertex shader operates on each vertex individually and outputs the modified vertex data to the subsequent stages, usually leading to the primitive assembly and rasterization stages.

Systems and techniques disclosed herein are directed towards an acceleration unit (AU) configured to implement a graphics pipeline utilizing deferred attribute shading. In certain embodiments, a primitive mesh shader handles initial processing of vertex data, including primitive assembly and vertex transformation; however, an attribute shader performs calculations of attribute data on a deferred basis—that is, only after an initial culling of primitives that are not relevant to (e.g., not potentially visible in) the scene being rendered. The primitive mesh shader handles the geometry of primitives by performing operations such as vertex pulling from vertex buffers and mesh shading, generating intermediate data for high-level geometry processing but stopping short of generating resource-intensive attribute data. Instead, an attribute shader performs attribute computations on a deferred post-culling basis. This deferral allows for a more efficient and targeted computation of vertex attributes, as the attribute shader only processes attributes for vertices of primitives that are determined to be visible in the scene.

Thus, the deferred attribute shading techniques described herein involve a strategic postponement of attribute computation for primitives until a relatively late stage in the rendering process, such as after initial geometric culling operations have identified those primitives that will contribute to the final rendered frame. By deferring the attribute shading in this manner, the AU is enabled to prioritize assignment of computational resources to only those primitives that are visible, potentially improving both the efficiency and speed of the rendering process by reducing unnecessary computations and memory bandwidth usage.

In certain embodiments, the AU leverages one or more shader engines to perform initial culling of primitives that are not relevant to (e.g., not visible in) the frame being rendered, to generate attribute data and geometric data for subsequent processing, and to perform subsequent attribute shading operations based on the culled and processed geometric data. The described techniques enable reductions in memory bandwidth usage by avoiding premature computation and storage of attribute data for primitives that may eventually be culled from the final scene.

The deferred attribute shading operations described herein are adaptable to various types of graphics pipelines, including but not limited to tile-based immediate-rendering (TBIR) pipelines. Therefore, in certain embodiments, systems and techniques disclosed herein are implemented via a processing system that comprises a TBIR graphics pipeline, such that the operations of the graphics pipeline involve first partitioning a frame to be rendered into two or more tiles. Further, the TBIR graphics pipeline includes determining which primitives of the frame to be rendered are at least partially visible in each tile and then sequentially rendering the primitives at least partially visible in each tile. While various examples are described herein within the context of a tile-based graphics pipeline, it will be appreciated that in various embodiments, aspects of rendering operations described herein (e.g., deferred attribute shading and related operations) are operable in a variety of other contexts, such as non-tile-based graphics pipelines. In addition, certain embodiments may operate within graphics pipelines utilizing other non-tile-based approaches to partitioning screen space as part of the rendering process, such that individual screen space partitions may each comprise any subset of the screen space for which a scene is to be rendered.

To implement a TBIR graphics pipeline, a processing system includes an acceleration unit (AU) configured to receive a command stream from an application being executed by the processing system. Such a command stream, for example, includes data indicating the primitives to be rendered for each frame of a series of frames. As an example, for a first frame of a set of frames, the command stream includes data including one or more geometry states, one or more pixel states, and data (e.g., vertices) indicating one or more primitives to be rendered in the frame. Such geometry states include data (e.g. parameters) to initialize and dictate tile-based immediate rendering, geometry stages of the TBIR graphics pipeline, or both. Additionally, such pixel states include data (e.g., parameters) to initialize and dictate tile draw stages, release stages, acquire stages, tile lighting stages, and discard stages of the tile-based immediate-rendering graphics pipeline. Based on receiving such a command stream, the AU first partitions the frame to be rendered into two or more tiles based on a geometry state indicated in the command stream. Further, the AU allocates a corresponding per-tile queue to each tile of the frame. The AU then, based on a second geometry state, performs a geometry stage of the pipeline. During such a geometry stage, the AU determines, for each tile in a group (e.g., batch) of tiles of the frame, which primitives of the frame are at least partially visible in the tile. Based on a primitive being at least partially visible in a tile, the AU stores geometry data indicating vertex data, shading data, positioning data, or any combination thereof of the primitive in the per-tile queue allocated to the tile.

After the AU has determined whether each primitive of the frame is at least partially visible in a first tile of the group of tiles, the AU initiates a tile draw stage of the TBIR graphics pipeline for the first tile based on a first pixel state from the command stream. During the tile draw stage for the first tile, the AU renders the primitives at least partially visible in the first tile into a geometry buffer (G-buffer) based on the geometry data stored in the per-tile queue allocated to the first tile. That is to say, based on the geometry data stored in the per-tile queue allocated to the first tile, the AU determines pixel attribute data indicating the position and color of the pixels of the primitives at least partially visible in the first tile. After such pixel attribute data associated with the first tile is written to the G-buffer, the AU, based on a second pixel state of the command stream, performs a tile lighting stage of the TBIR graphics pipeline for the first tile. During the tile lighting stage for the first tile, the AU is configured to, based on the pixel attribute data associated with the first tile in the G-buffer, determine lighting data (e.g., intensity data) for each pixel of the primitives at least partially visible in the first tile. The AU then stores data representing the position, color, and lighting for each pixel of the primitives at least partially visible in the first tile to a frame buffer for display. Based on subsequent pixel states from the command stream, the AU then performs tile draw stages and tile lighting stages for the remaining tiles in the group of tiles.

In this way, the processing system implements the TBIR graphics pipeline. Because the AU renders primitives based on a single command stream from an application, the processing system is not required to manage in-memory state objects to allow access to stored states by, for example, the AU. As such, the complexity and resources required to render the primitives is reduced, helping to improve processing efficiency. Additionally, because the AU determines lighting data for pixels from the pixel attribute data in the G-buffer, the AU is not required to repeat the assembly and shading of primitives during the tile lighting stages, helping to reduce the processing resources and processing time needed to render the primitives. Further, in some instances, once the AU has completed a tile draw stage of the graphics pipeline for a first tile, the AU is configured to release the pixel attribute data associated with that first tile from the G-buffer. As the pixel attribute data associated with that first tile is released from the G-buffer, the AU is configured to, based on a corresponding pixel state of the command stream, perform a tile draw stage for a second tile of the group of tiles. In this way, AU is not required to wait until the pixel attribute data is released before performing a next stage of the TBIR pipeline, reducing the amount of time needed to perform the stages of the TBIR pipeline.

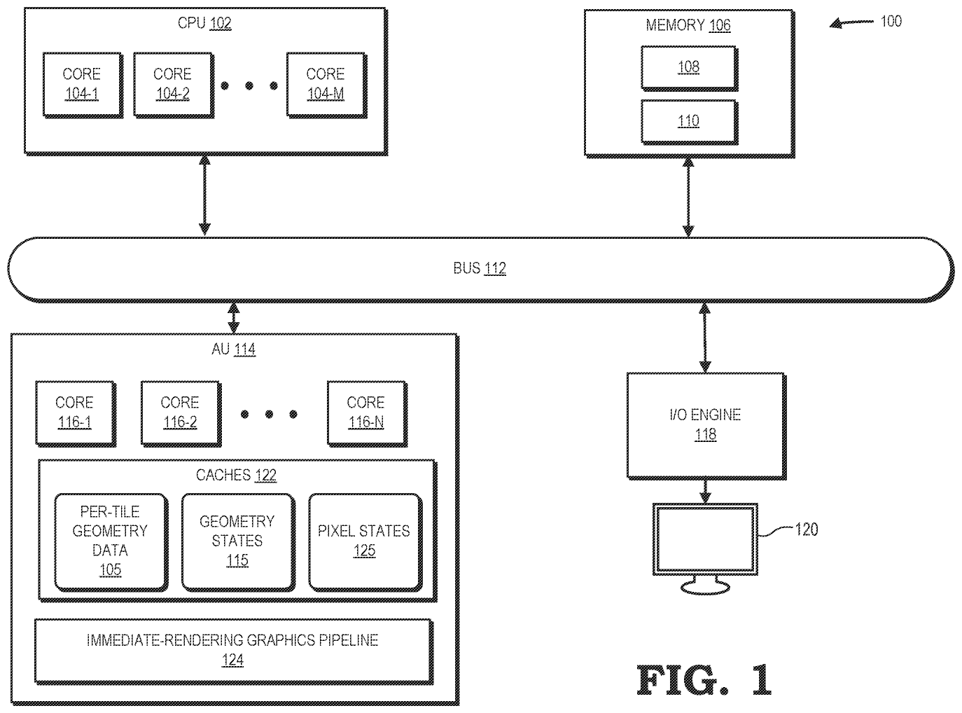

FIG. 1 is a block diagram of a processing system 100 configured to implement a tile-based immediate-rendering graphics pipeline, according to some implementations. The processing system 100 includes a central processing unit (CPU) 102 that is communicatively coupled to a memory 106 via a bus 112. In embodiments, the memory 106 includes a storage component implemented using a non-transitory computer-readable medium such as a dynamic random-access memory (DRAM), static random-access memory (SRAM), nonvolatile RAM, and the like. In certain implementations, the memory 106 includes an external memory implemented external to the processing units of the processing system 100. The bus 112 supports communication between entities implemented in the processing system 100, including the CPU 102 and the memory 106. Some implementations of the processing system 100 include other buses, bridges, switches, routers, and the like, which are not shown in FIG. 1 in the interest of clarity.

The techniques described herein are, in different implementations, employed at acceleration unit (AU) 114. AU 114 includes, for example, one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., field-programmable gate arrays) or any combination thereof. In various embodiments, AU 114 renders scenes within a screen space (e.g., the space in which a scene is displayed) according to one or more applications 108 executing in memory 106 for presentation on a display 120, which is communicatively coupled to bus 112 via an input/output (I/O) engine 118. For example, AU 114 renders graphics objects (e.g., sets of primitives) of a scene in a screen space (e.g., display space) to be displayed to produce values of pixels that are provided to the display 120, which uses the pixel values to display a scene that represents the rendered graphics objects. To render these graphics objects, AU 114 implements a plurality of processor cores 116-1 to 116-N that execute instructions concurrently or in parallel. For example, AU 114 executes instructions from one or more graphics pipelines (e.g., tile-base immediate-rendering graphics pipeline 124) using a plurality of processor cores 116 to render one or more graphics objects. A graphics pipeline, for example, includes one or more steps, stages, or instructions to be performed by AU 114 in order to render one or more graphics objects for a scene. As an example, a graphics pipeline includes data indicating an assembler stage, vertex shader stage, hull shader stage, tessellation stage, domain shader stage, geometry shader stage, binning stage, rasterizer stage, pixel shader stage, output merger stage, or any combination thereof to be performed by one or more processor cores 116 of AU 114 in order to render one or more graphics objects for a scene.

In embodiments, one or more processor cores 116 of AU 114 each operate as a compute unit configured to perform one or more operations for one or more instructions received by AU 114. These compute units each include one or more single instruction, multiple data (SIMD) units that perform the same operation on different data sets to produce one or more results. For example, AU 114 includes one or more processor cores 116 each functioning as a compute unit that includes one or more SIMD units to perform operations for one or more instructions from a graphics pipeline (e.g. TBIR graphics pipeline 124). To facilitate one or compute units performing operations for instructions from a graphics pipeline, AU 114 includes one or more command processors (not shown for clarity). Such command processors, for example, include circuitry configured to execute one or more instructions from a graphics pipeline by providing data indicating one or more operations, operands, instructions, variables, register files, or any combination thereof to one or more compute units necessary for, helpful for, or aiding in the performance of one or more operations for the instructions. Though the example implementation illustrated in FIG. 1 presents AU 114 as having three processor cores (116-1, 116-2, 116-N) representing an N number of cores, the number of processor cores 116 implemented in the AU 114 is a matter of design choice. As such, in other implementations, AU 114 can include any number of processor cores 116.

According to embodiments, one or more processor cores 116 of AU 114 each operating as one or more compute units are configured to store results (e.g., data resulting from the performance of one or more instructions, operations, or both) in one or more caches 122, memory 106, or both. Such caches 122, for example, include one or more caches 122 included in or otherwise connected to processor cores 116. As an example, in embodiments, cache 122 includes one or more caches shared between two or more of the processor cores 116 (e.g., shared caches), one or more caches private to (e.g., only accessibly by) a single corresponding processor core 116 (e.g., private caches), or both. For example, according to some embodiments, cache 122 includes a cache hierarchy including one or more private caches, one or more shared caches, or both.

In embodiments, AU 114 is configured to render one or more graphics objects based on tile-based immediate-rendering (TBIR) graphics pipeline 124. For example, the graphics pipeline 124 includes an immediate rendering mode in which an application 108 issues a command stream including data describing all the graphics objects (e.g., primitives) in a scene to be rendered for each frame to be rendered. In the depicted embodiment, a command stream includes data indicating the position of vertices of one or more primitives to be rendered, one or more geometry states 115, and one or more pixel states 125. Such geometry states 115, for example, include data (e.g. parameters) to initialize and dictate tile-based immediate rendering for the TBIR graphics pipeline 124, geometry stages of the TBIR graphics pipeline 124, or both. As an example, a geometry state 115 indicates parameters, processes, and data used in initializing or performing tile-based immediate-rending or a geometry stage of TBIR graphics pipeline 124. Additionally, such pixel states 125 include data (e.g., parameters) to initialize and dictate tile draw stages, release stages, acquire stages, tile lighting stages, and discard stages of the TBIR graphics pipeline 124. For example, a pixel state 125 indicates parameters, processes, and data used in the tile draw stages, release stages, acquire stages, tile lighting stages, and discard stages of the TBIR graphics pipeline 124. In embodiments, AU 114 is configured to store the geometry states 115 and pixel states 125 indicated in a command stream in one or more caches 122, memory 106, or both.

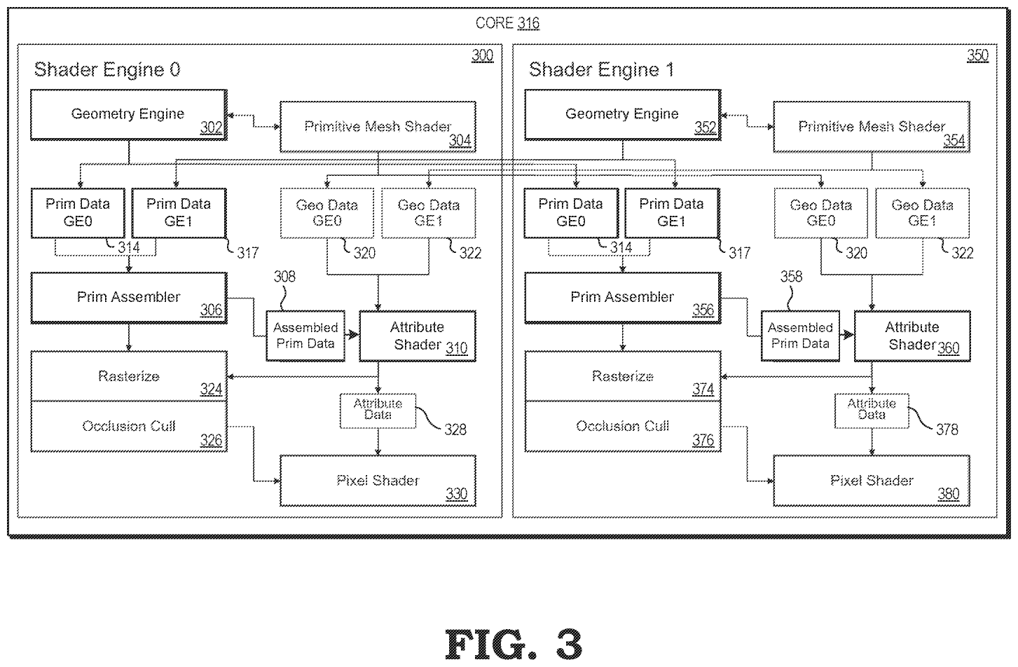

In various embodiments, per-tile geometry data 105, geometry states 115, and pixel states 125 facilitate or are impacted by the deferred processing of attribute data, particularly in optimizing rendering based on the visibility and relevance of individual primitives. For example, per-tile geometry data 105, which includes information regarding those primitives that are at least partially visible within each tile, facilitates identifying (with additional reference to FIG. 3, discussed elsewhere herein) which primitives are relevant for such deferred attribute shading operations, and thereby enables attribute shading operations to be performed only on relevant primitives. The deferred processing approach leverages the per-tile geometry data 105 to postpone attribute computations until it is confirmed that these primitives contribute to the final rendered image. Geometry states 115 define how the geometry of each tile is processed (enabling AU 114 to identify and prioritize the rendering of primitives based on their visibility and relevance) and include parameters and instructions for the initial stages of rendering, including the culling and preparation of primitives for attribute shading. Pixel states 125 further refine the rendering process by specifying how the pixels within each tile are to be drawn and shaded, based on the deferred attribute data. These states contain instructions for the final stages of rendering, including tile draw stages and lighting calculations, which are directly impacted by the attribute data generated during deferred shading operations.

According to embodiments, the TBIR graphics pipeline 124 includes partitioning a frame to be rendered into two or more tiles and then rendering the graphics objects of the scene tile by tile. For example, based on a first geometry state 115 in a received command stream, AU 114 first partitions a frame to be rendered into two or more tiles (e.g., coarse tiles). Each tile, for example, includes a first number of pixels of the frame in a first direction (e.g., horizontal direction) and a second number of pixels of the frame in a second direction (e.g., vertical direction) perpendicular to the first direction indicated by the first geometry state 115. According to some embodiments, a tile includes the same number of pixels in the first and second directions while in other embodiments the tile includes a different number of pixels in the first and second directions.

After partitioning the frame to be rendered into two or more tiles, AU 114 then allocates a number of queues formed from at least a portion of caches 122, memory 106, or both to each tile in a group (e.g., batch) of tiles of the frame such that each tile of the group of tiles has a corresponding per-tile queue. As an example, AU 114 divides and allocates one or more per-shader engine queues formed from portions of caches 122 such that each tile of a group of tiles is allocated a per-tile queue. Each per-tile queue, for example, includes one more queues formed from at least a portion of caches 122, memory 106, or both. After AU 114 has allocated a per-tile queue to each tile in the group of tiles, AU 114 beings a geometry stage of TBIR graphics pipeline 124 based on a second geometry state 115 of the command stream.

Such a geometry stage, for example, includes a visibility pass in which AU 114 determines which primitives (e.g., graphics objects) are to be rendered for each tile in the group of tiles. For example, based on data indicating vertices of one or more primitives to be rendered in the command stream, AU 114 assembles (e.g., performs an assembly stage) and shades (e.g., performs one or more shaders) the indicated primitives. For each tile of the group of tiles, AU 114 then determines whether each of the assembled primitives is at least partially visible (e.g., relevant). Based on AU 114 determining that an assembled primitive is at least partially visible in a tile, AU 114 provides geometry data indicating vertex data, shading data, positioning data, or any combination thereof of the primitive to the per-tile queue associated with the tile. Once AU 114 has determined whether each primitive indicated in the command stream from the application 108 is visible in a tile, the per-tile queue allocated to the tile stores per-tile geometry data 105 that represents the vertex data, shading data, positioning data, or any combination of the primitives at least partially visible within the tile.

Once AU 114 has determined whether each assembled primitive is visible in a first tile of the frame to be rendered, AU 114 begins a first tile draw stage for the first tile based on a first pixel state 125 indicated in the command stream. As an example, after AU 114 has determined whether each assembled primitive is visible in a first tile of a group of tiles and concurrently with AU 114 performing a remainder of the geometry stage, AU 114 begins a first tile draw stage for the first tile based on a first pixel state 125. To perform such a tile draw stage, AU 114 is configured to first render the primitives at least partially visible in the first tile as a batch (e.g., coarse batch) to a G-buffer formed from at least a portion of caches 122, memory 106, or both. To this end, AU 114 is configured to render the primitives at least partially visible in the first tile based on the per-tile geometry data 105 stored in the per-tile queue associated with the first tile. As an example, AU 114 first drains the per-tile queue associated with the first tile of the per-tile geometry data 105 representing the primitives at least partially visible in the first tile. Based on the first pixel state 125, AU 114 then assembles, rasterizes, and shades the primitives using the per-tile geometry data 105 to produce per-tile pixel attribute data that is stored in the G-buffer and per-tile pixel depth data that is stored in a depth buffer (e.g., Z-buffer) formed from at least a portion of caches 122, memory 106, or both. Such per-tile pixel attribute data represents the attributes (e.g., color, position) of the pixels forming the primitives at least partially visible in the tile and such per-tile pixel depth data represents the depth of the pixels forming the primitives at least partially visible in the tile.

According to embodiments, the tile draw stage further includes AU 114 performing one or more depth culling techniques based on the per-tile pixel depth data in the Z-buffer and the first pixel state 125. For example, for each pixel forming a primitive at least partially visible in a tile, AU 114 compares the depth value of the pixel to one or more pre-determined threshold values. Based on the comparison of the depth value of the pixel to the predetermined threshold values, AU 114 then culls the pixel from the Z-buffer, G-buffer, or both by, for example, not storing the pixel attribute data or pixel depth data in the G-buffer or Z-buffer, respectively. As an example, based a comparison of the depth value of a pixel to the predetermined threshold values indicating that the pixel is at least partially occluded (e.g., at least a portion of the pixel is not visible in the scene), AU 114 then culls the pixel.

After AU 114 has completed a tile draw stage for a first tile and based on a second pixel state 125, AU 114 releases the per-tile pixel attribute data in the G-buffer and performs a tile lighting stage using the released per-tile pixel attribute data. For example, during the tile lighting stage, AU 114 performs one or more pixel-shading operations as indicated in a pixel state 125 so as to determine lighting values (e.g., intensity values) that represent the direct and indirect lighting for each pixel forming primitives at least partially visible in the tile using the per-tile pixel attribute data in the G-buffer. AU 114 then stores pixel values representing the color and lighting (e.g., intensity) of each pixel forming primitives at least partially visible in the tile in a frame buffer formed from at least a portion of caches 122, memory 106, or both. Further, once AU 114 has determined the lighting values for each pixel forming primitives at least partially visible in the tile, AU 114 discards the per-tile pixel attribute data stored in the G-buffer associated with the tile. In embodiments, while AU 114 releases the per-tile pixel attribute data in the G-buffer is released to perform a tile lighting stage for a first tile, AU 114 is configured to perform a tile draw stage for a second tile of the frame, a tile lighting stage for a second tile of the frame, or both. As an example, while the per-tile pixel attribute data in the G-buffer is released to perform a tile lighting stage for a first tile, AU 114 performs a tile draw stage for a second tile, stores the per-tile pixel attribute data of the primitives in the second tile in the G-buffer, and releases the per-tile pixel attribute data of the primitives in the second tile in the G-buffer so as to perform a lighting stage for the second tile. Further, as an example, as AU 114 releases the per-tile pixel attribute data of the primitives in the second tile in the G-buffer, AU 114 performs the lighting stage for the first tile and a draw stage for a third tile. Due to AU 114 performing such stages while per-tile pixel attribute data is released from the G-buffer, AU 114 is not required to wait for the per-tile pixel attribute data to be released before starting a next stage of the TBIR graphics pipeline 124, helping reduce pauses between the stages and helping to decrease the time needed to render the primitives.

In this way, AU 114 is configured to implement a TBIR graphics pipeline 124. Because TBIR graphics pipeline 124 has AU 114 rendering primitives based on a single command stream from an application 108, processing system 100 is not required to manage in-memory state objects to allow access to stored states by AU 114, reducing the complexity and resources required to render the primitives. Additionally, since the AU 114 determines pixel light values from the per-tile pixel attribute data in the G-buffer, the assembly and shading of primitives done during the tile draw stages are not repeated during the tile lighting stages, reducing processing resources and time associated with rendering the primitives. Further, because TBIR graphics pipeline 124 includes rendering primitives tile by tile rather than for the entire frame at once, the processing resources needed at any one time are reduced, helping to decrease power consumption and improve the processing efficiency of processing system 100.

In the depicted example, CPU 102 implements a plurality of processor cores 104-1 to 104-N that execute instructions concurrently or in parallel. In at least some implementations, one or more of the processor cores 104 operate as SIMD units that perform the same operation on different data sets. For example, one or more processor cores 104 operate as SIMD units each having two or more lanes each configured to perform an operation (e.g., spatial test) of a wave. Though three processor cores (104-1, 104-2, 104-M) are presented representing an M number of cores, the number of processor cores 104 implemented in the CPU 102 is a matter of design choice. As such, in other implementations, the CPU 102 can include any number of processor cores 104. In some implementations, the CPU 102 and AU 114 have an equal number of processor cores 104, 116 while in other implementations, the CPU 102 and AU 114 have a different number of processor cores 104, 116. The processor cores 104 execute instructions such as program code 110 for one or more applications 108 stored in the memory 106 and the CPU 102 stores information in the memory 106 such as the results of the executed instructions. The CPU 102 is also able to initiate graphics processing by issuing a command stream from one or more application 108 to AU 114.

The input/output (I/O) engine 118 includes hardware and software to handle input or output operations associated with the display 120, as well as other elements of the processing system 100 such as keyboards, mice, printers, external disks, and the like. The I/O engine 118 is communicatively coupled to one or more of the memory 106, the AU 114, or the CPU 102 via the bus 112.

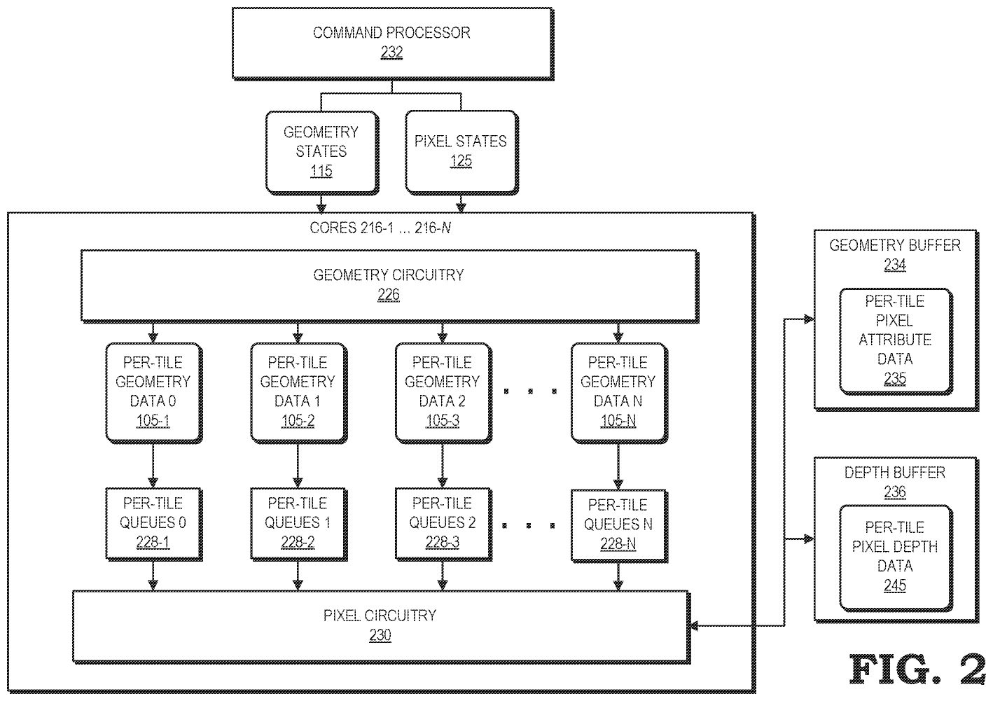

Referring now to FIG. 2, collective operations of AU processor cores 216-1 through 216-N (collectively referred to herein as processor cores 216) configured to implement at least a portion of a tile-based immediate-rendering pipeline are presented in accordance with embodiments. In some embodiments, processor cores 216 are implemented within AU 114 (with reference to FIG. 1) as processor cores 116-1 through 116-N. According to embodiments, processor cores 216 are configured to implement at least a portion of TBIR graphics pipeline 124 by executing one or more instructions, operations, or both associated with TBIR graphics pipeline 124. To this end, processor cores 216 are communicatively coupled to command processor 232. Command processor 232, for example, includes circuitry configured to receive a command stream from an application 108. Such a command stream, for example, includes one or more geometry states 115, pixel states 125, and data indicating one or more primitives to be rendered in a scene of a frame. Command processor 232 then provides data indicating the geometry states 115, pixel states 125, and primitives to be rendered (e.g., vertex data) to processor cores 216. Such geometry states 115, for example, include data (e.g. parameters) to initialize and dictate tile-based immediate rendering for the tile-based immediate-rending graphics pipeline 124, geometry stages of the TBIR graphics pipeline 124, or both. Additionally, such pixel states 125 include data (e.g., parameters) to initialize and dictate tile draw stages, release stages, acquire stages, tile lighting stages, and discard stages of the TBIR graphics pipeline 124.

Based on a first geometry state 115 provided from command processor 232, processor cores 216 first partition the frame to be rendered into a number of tiles indicated by the first geometry state 115. Each tile, for example, includes a number of pixels in a first direction and a number of pixels in a second direction as indicated by the first geometry state 115. After partitioning the frame into tiles, processor cores 216 then allocate a per-tile queue 228 to each frame in a group of frames as indicated by the first geometry state 115. For example, AU 114 allocates a first per-tile queue 0 228-1 to a first tile of a group of tiles, a second per-tile queue 1 228-2 to a second tile of the group of tiles, a third per-tile queue 2 228-3 to a third tile of the group of tiles, and a fourth per-tile queue N 228-N to a fourth tile of the group of tiles. Such per-tile queues 228 are each formed from at least a portion of caches 122, memory 106, or both and include one or more queues, for example, first in, first out (FIFO) queues. Though the example embodiment presented in FIG. 2 shows processor cores 216 with four groups of per-tile queues 228 representing an N number of per-tile queues 228 that support an N number of tiles of a frame, in other embodiments, processor cores 216 can include any number of per-tile queues 228 supporting any number of tiles of a frame. Further, in some embodiments, each per-tile queue 228 is formed from one or more per-shader queues of processor cores 216.

Based on a second geometry state 115 of the command stream, processor cores 216 then perform a geometry stage (e.g., visibility pass) to determine which primitives to be rendered for the frame are at least partially visible in each tile of the group of tile (e.g., the tiles having an allocated per-tile queue 228). To this end, processor cores 216 include or are otherwise communicatively coupled to a geometry circuitry 226 configured to implement one or more primitive assemblers, shaders (e.g., geometry shaders), or both so as to assemble and shade one or more primitives based on the second geometry state 115. As an example, based on the second geometry state 115 and data indicating the primitives to be rendered for the frame, geometry circuitry 226 assembles and shades each indicated primitive. Once geometry circuitry 226 has assembled and shaded the indicated primitives, geometry circuitry 226 then determines whether each of the assembled primitives is at least partially visible (e.g., relevant) in each tile of the group of frames. Based on an assembled primitive being at least partially visible in a tile, geometry circuitry 226 provides geometry data representing the vertex data, shading data, positioning data, or any combination of the primitive to the per-tile queue 228 allocated to the tile.

Once geometry circuitry 226 has stored the geometry data representing each primitive at least partially visible in a tile to a corresponding per-tile queue 228, such stored data is represented in FIG. 2 as per-tile geometry data 105. Such per-tile geometry data (105-1, 105-2, 105-3, 105-N) each represents the vertex data, shading data, positioning data, or any combination of the primitives at least partially visible within a corresponding tile. According to embodiments, once geometry circuitry 226 has stored the per-tile geometry data 105 for a first tile in a corresponding per-tile queue 228 (e.g., per-tile queue 228), processor cores 216 are configured to perform a tile draw stage for the first tile based on a first pixel state 125. As an example, currently with geometry circuitry 226 completing a remainder of the geometry stage, processor cores 216 are configured to perform a tile draw stage for the first tile based on a first pixel state 125. To this end, processor core 116 includes pixel circuitry 230 configured to implement one or more assemblers, shaders (e.g., fragment shaders), or both based on corresponding pixel states 125.

As an example, to perform a tile draw stage of TBIR graphics pipeline 124 for a first tile, pixel circuitry 230 is configured to first drain the per-tile queue 228 (e.g., per-tile queue 0 228-1) associated with the first tile so as to receive the per-tile geometry data 105 (e.g., per-tile geometry data 105-1) associated with the first tile. After obtaining the per-tile geometry data 105 associated with the first tile, pixel circuitry 230 then renders the primitives indicated in the per-tile geometry data 105-1 as a batch (e.g., coarse batch) to a G-buffer 234 based on the first pixel state 125. That is to say, AU 114 assembles, rasterizes, and shades the primitives indicated in the per-tile geometry data 105 based on the first pixel state 125 to produce per-tile pixel attribute data 235 that is stored in the G-buffer 234. Further, based on assembling, rasterizing, and shading these primitives based on per-tile geometry data 105, pixel circuitry 230 produces per-tile depth data 245 that is stored in a Z-buffer 236. The G-buffer 234 and Z-buffer 236, for example, each includes a respective buffer formed from at least corresponding portions of caches 122, memory 106, or both. Further, the per-tile pixel attribute data 235 stored in the G-buffer 234 represents the attributes (e.g., color, position) of the pixels forming the primitives at least partially visible in the first tile and the per-tile depth data 245 stored in the Z-buffer 236 represents the depth of the pixels forming the primitives at least partially visible in the first tile. According to embodiments, a tile draw stage further includes pixel circuitry 230 performing one or more depth culling techniques on the per-tile depth data 245 as indicated by the first pixel state 125. As an example, for each pixel forming a primitive at least partially visible in a tile, AU 114 compares the depth value of the pixel indicated in the per-tile depth data 245 to one or more pre-determined threshold values indicated in the first pixel state 125. Based on the comparison of the depth value of the pixel to the predetermined threshold values, pixel circuitry 230 culls the pixel from the Z-buffer 236, G-buffer 234, or both by, for example, not providing the per-tile pixel attribute data 235 or per-tile depth data 245 associated with the pixel to the G-buffer 234 or Z-buffer 236, respectively. As an example, based a comparison of the depth value of a pixel as indicated by per-tile depth data 245 to the predetermined threshold values indicating that the pixel is at least partially occluded (e.g., at least a portion of the pixel is not visible in the scene), pixel circuitry 230 then culls the pixel from the Z-buffer 236, G-buffer 234, or both.

After pixel circuitry 230 has completed the tile draw phase for the first tile and based on a second pixel state 125, pixel circuitry then releases the per-tile pixel attribute data 235 in the G-buffer 234 such that pixel circuitry is able to perform a lighting stage of the TBIR graphics pipeline 124 for the first tile. To perform such a lighting stage for the first tile, pixel circuitry 230 is configured to receive a third pixel state 125. As indicated the third pixel state 125, pixel circuitry 230 performs one or more pixel-shading operations using the per-tile pixel attribute data 235 associated with the first tile so as to determine lighting values (e.g., intensity values) that represent the direct and indirect lighting for each pixel forming primitives at least partially visible in the first tile. Pixel circuitry 230 then stores the pixel values representing the color and lighting (e.g., intensity) of each pixel forming primitives at least partially visible in the tile in a frame buffer (not shown for clarity) formed from at least a portion of caches 122, memory 106, or both. Further, once pixel circuitry 230 has determined the lighting values for each pixel forming primitives at least partially visible in the first tile and based on a fourth pixel state 125, pixel circuitry 230 discards the per-tile pixel attribute data 235.

According to embodiments, while pixel circuitry 230 releases the per-tile pixel attribute data 235 associated with the first tile in the G-buffer 234 to perform a tile lighting stage for the first tile, AU 114 is configured to perform a tile draw stage for a second tile of the frame, a tile lighting stage for a second tile of the frame, or both. As an example, while the per-tile pixel attribute data 235 associated with the first tile is released and based on a corresponding pixel state 125, pixel circuitry 230 performs a tile draw stage for a second tile, stores the per-tile pixel attribute data 235 of the second tile in the G-buffer 234, and releases the per-tile pixel attribute data 235 of the second tile in the G-buffer 234 so as to perform a lighting stage for the second tile. Further, as an example, as pixel circuitry 230 releases the per-tile pixel attribute data 235 of the second tile in the G-buffer 234 and based on corresponding pixel states 125, pixel circuitry 230 performs the lighting stage for the first tile and a draw stage for a third tile.

FIG. 3 is a block diagram of an acceleration unit core 316 that comprises (along with interconnecting circuitry omitted for clarity) two shader engines 300 (SE0) and 350 (SE1), each of which is configured to perform, inter alia, deferred attribute shading operations as part of graphics pipeline 124 (with reference to FIG. 1). In some embodiments, acceleration unit core 316 is implemented within AU 114 (with reference to FIG. 1) as one of processor cores 116-1 through 116-N.

In the depicted embodiment, the shader engines 300, 350 share primitive and geometry data as discussed below. However, it will be appreciated that in various embodiments, an AU core may comprise any quantity of shader engines, and may be configured to share such primitive and geometry data between any number of those shader engines, or configured such that each shader engine utilizes only primitive and geometry data generated locally to that shader engine.

Shader engine 300 (SE0) includes a geometry engine 302, which performs initial culling of geometry primitives to identify (such as based on per-tile geometry data 105 and/or geometry states 115) those that are relevant for subsequent processing, and to generate primitive data 314 to facilitate that subsequent processing. Primitive data 314 typically includes information about the geometric primitives (such as vertices, lines, triangles) identified to be processed, including their indices and basic attributes necessary for primitive assembly and culling.

The primitives identified as relevant by geometry engine 302 are processed by the primitive mesh shader block 304 (in accordance with pixel states 125), which performs various shader operations to transform and prepare the identified relevant primitives for rendering by generating geometry data 320 for subsequent processing. In various embodiments and scenarios, geometry data 320, 322 includes, as non-limiting examples, the transformed positions of vertices, normals, and/or other geometric characteristics that result from the execution of vertex or geometry shaders. This data is used for further geometric processing, including clipping, tessellation, and setup for subsequent rasterization.

In the depicted embodiment, a primitive assembler 306 processes assembled primitive data based on primitive data 314 from geometry engine 302 and primitive data 317 from geometry engine 352. The primitive assembler 306 then provides the assembled primitive data 308 to the attribute shader 310 and to the rasterizer 324. In the depicted embodiment, a primitive assembler 306 aggregates and organizes the primitive data 314, 317 for subsequent processing, such as by aligning primitive data like vertices and indices to facilitate subsequent attribute shading and rasterization.

The attribute shader 310 performs attribute shading operations on a deferred basis relative to typical graphics pipelines. Such operations generate attribute data 328 by determining or modifying one or more attributes of vertices or primitives (e.g., by calculating lighting effects, texture mapping coordinates, vertex colors, etc.) By deferring these operations until after the initial geometry culling—thereby generating attribute data only for primitives that have passed the culling process of geometry engines 302, 352—the AU core 316 improves rendering efficiency by assigning greater computational resources to the processing of only geometry that contributes to the final rendered image. This reduces the overhead associated with processing attributes for primitives that would eventually be discarded due to occlusion or being outside the view frustum, for example.

The attribute shader 310 provides processed attribute data 328 to rasterizer 324, which transforms geometric data into pixel data, and to pixel shader 330, which generates the final pixel values for rendering after the occlusion cull block 326 performs culling operations on the output of rasterizer 324 (such as to eliminate unnecessary processing of occluded primitives by the pixel shader 330).

In the depicted embodiment, the shader engine 350 is substantially identical to shader engine 300, with geometry engine 352, primitive mesh shader 354, primitive assembler 356, attribute shader 360, rasterizer 374, occlusion cull block 376, and pixel shader 380 performing operations substantially identical to those respectively described above with respect to geometry engine 302, primitive mesh shader 304, primitive assembler 306, attribute shader 310, rasterizer 324, occlusion cull block 326, and pixel shader 330. The shader engines 300, 350 of AU core 316 operate together to generate primitive data 314, 317 and geometry data 320, 322 for subsequent processing by each of those shader engines 300, 350. Moreover, in the depicted embodiment, primitive data 314, 317, geometry data 320, 322, assembled primitive data 308, 358, and attribute data 328, 378 are advantageously retained and used within the AU core 316, avoiding cross-core data traffic and the latencies and accompanying resource consumption associated with such data traffic.

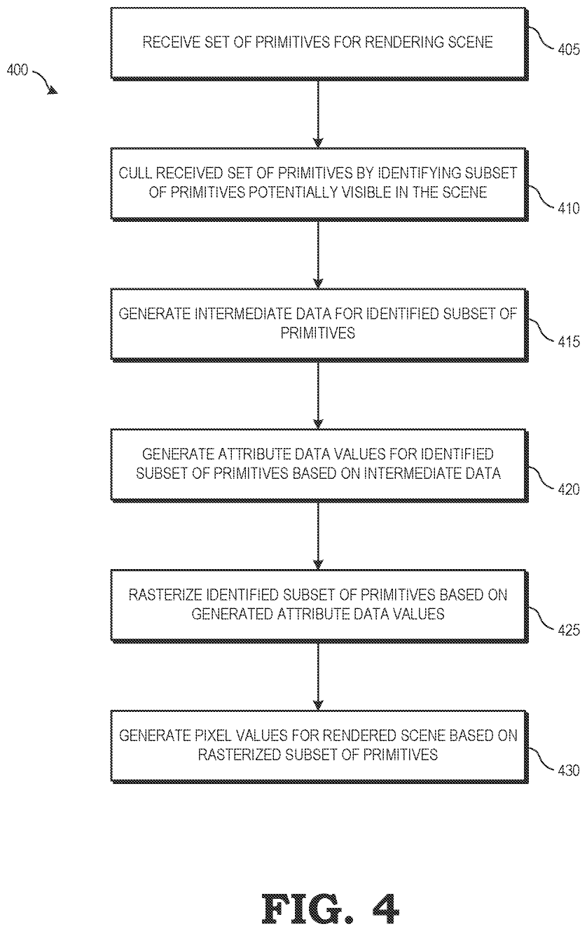

FIG. 4 depicts a flow diagram for an operational routine 400 of one or more shader engines implementing deferred attribute shading operations, in accordance with some embodiments. The routine may be performed, for example, by one or more processing cores (e.g., cores 116-1 . . . 116-N of FIG. 1, cores 216-1 . . . 216-N of FIG. 2, and/or core 316 of FIG. 3), such as via one or more shader engines (e.g., shader engines 300, 350 of FIG. 3) of those processing cores. Although the operational routine 400 is described below as if performed by a single shader engine, it will be appreciated that in various embodiments the described operations may be performed by one or more shader engines across one or more processing cores, such as described elsewhere herein.

The routine begins at block 405, in which the shader engine receives a set of primitives designated for rendering a scene. These primitives, constituting the raw geometric data, are the fundamental elements that will be processed to create the final visual output for the scene being rendered.

The routine advances to block 410, in which the received set of primitives is culled. During this culling stage, the shader engine identifies a subset of the primitives that are potentially visible within the scene, effectively filtering out those that will not contribute to the scene as perceived by the viewer. Thus, those primitives that are not potentially visible within the scene—whether due to occlusion or being outside the screen space—are culled, leaving for further processing only those primitives that are potentially visible within the scene. This culling enhances rendering efficiency by reducing the workload in subsequent processing stages. Once the potentially visible subset of primitives is established, the routine proceeds to block 415.

At block 415, the shader engine generates intermediate data for the culled subset of primitives. As discussed elsewhere herein, this intermediate data may include, as non-limiting examples, one or more of primitive data (e.g., primitive data 314, 317); geometry data (e.g., geometry data 320, 322); assembled primitive data 308, 358, which aggregates and organizes the primitive data for efficient subsequent processing; and attribute data (e.g., attribute data 328, 378). The routine proceeds to block 420.

At block 420, the shader engine leverages the intermediate data to generate attribute data values for the identified subset of primitives. As discussed in greater detail elsewhere herein, such attribute data values may include, as non-limiting examples: color, normal vectors, texture coordinates, lighting information, etc. Following the computation of attribute data, the routine proceeds to block 425.

At block 425, the shader engine rasterizes the identified subset of primitives based on the generated attribute data values. Rasterization converts the geometric representation of primitives into pixel data for the scene, mapping the attribute data onto the two-dimensional screen space. The routine proceeds to block 430.

At block 430, the shader engine generates pixel values for the rendered scene based on the rasterized subset of primitives. In various embodiments and scenarios, the generating of the pixel values may include applying final color and lighting calculations to the rasterized data, which result in the pixel values that are output to the display to create the rendered scene as observed by a user.

In some embodiments, the apparatus and techniques described above are implemented in a system including one or more integrated circuit (IC) devices (also referred to as integrated circuit packages or microchips), such as the acceleration unit and components thereof described herein with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry”, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, by one or more shader engines, a set of primitives for rendering at least a portion of a scene;
culling the set of primitives by the one or more shader engines, wherein culling the set of primitives comprises identifying a subset of the primitives that are potentially visible in the scene;
generating, by the one or more shader engines, attribute data values for the identified subset of primitives; and
rasterizing the identified subset of primitives, by the one or more shader engines, for rendering based on the generated attribute data values.

2. The method of claim 1, further comprising generating, by the one or more shader engines, intermediate data for the identified subset of primitives, and wherein the method is performed without providing, external to the one or more shader engines, the intermediate data or the attribute data values.

3. The method of claim 2, wherein:
generating the intermediate data for the identified subset of primitives comprises generating intermediate geometry data for the identified subset; and
rasterizing the identified subset of primitives comprises rasterizing the identified subset based on the intermediate geometry data.

4. The method of claim 2, wherein:
generating the intermediate data for the identified subset of primitives comprises generating assembled primitive data for the identified subset of primitives; and
generating the attribute data values comprises generating the attribute data values based on the assembled primitive data.

5. The method of claim 1, wherein rasterizing the identified subset of primitives comprises generating a rasterized subset of primitives, and wherein the method further comprises rendering the scene by generating pixel data based on the rasterized subset of primitives.

6. The method of claim 1, further comprising splitting the scene into a plurality of tiles, wherein the set of primitives corresponds to all primitives associated with one tile of the plurality of tiles.

7. The method of claim 1, wherein receiving the set of primitives comprises receiving one or more of a group that includes geometry data associated with the set of primitives, geometry state data associated with the scene, or pixel state data.

8. The method of claim 1, wherein the method is performed by a processor core comprising the one or more shader engines.

9. An acceleration unit comprising:
one or more caches; and
one or more shader engines coupled to the one or more caches, the one or more shader engines configured to:
receive a set of primitives for rendering at least a portion of a scene;
cull the set of primitives to identify a subset of the primitives that are potentially visible in the scene;
generate attribute data values for the identified subset of primitives; and
rasterize the identified subset of primitives for rendering based on the generated attribute data values.

10. The acceleration unit of claim 9, wherein the one or more shader engines are further configured to generate intermediate data for the identified subset of primitives, and to generate the attribute data values and rasterize the identified subset of primitives without providing, external to the one or more shader engines, the intermediate data or the attribute data values.

11. The acceleration unit of claim 10, wherein:
the intermediate data for the identified subset of primitives includes intermediate geometry data for the identified subset; and
the one or more shader engines are configured to rasterize the identified subset of primitives based on the intermediate geometry data.

12. The acceleration unit of claim 10, wherein:
the intermediate data for the identified subset of primitives comprises assembled primitive data for the identified subset of primitives; and
the one or more shader engines are configured to generate the attribute data values based on the assembled primitive data.

13. The acceleration unit of claim 9, wherein to rasterize the identified subset of primitives comprises generating a rasterized subset of primitives, and wherein the one or more shader engines are configured to render the scene by generating pixel data based on the rasterized subset of primitives.

14. The acceleration unit of claim 9, wherein the scene is divided into a plurality of tiles, and wherein the set of primitives corresponds to all primitives associated with one tile of the plurality of tiles.

15. The acceleration unit of claim 9, wherein the set of primitives comprises one or more of a group that includes geometry data associated with the set of primitives, geometry state data associated with the scene, or pixel state data.

16. A non-transitory computer readable medium embodying a set of executable instructions, the set of executable instructions to manipulate at least one processor to:
receive a set of primitives for rendering at least a portion of a scene;
identify, by a shader engine of the at least one processor, a subset of the primitives that are potentially visible in the scene;
generate, by the shader engine, attribute data values for the identified subset of primitives; and
rasterize, by the shader engine, the identified subset of primitives for rendering based on the generated attribute data values.

17. The non-transitory computer readable medium of claim 16, wherein the set of executable instructions manipulate the shader engine to generate intermediate data for the identified subset of primitives, and to generate the attribute data values and rasterize the identified subset of primitives without providing, external to the shader engine, the intermediate data or the attribute data values.

18. The non-transitory computer readable medium of claim 17, wherein:
the intermediate data for the identified subset of primitives includes intermediate geometry data for the identified subset; and
the shader engine is configured to rasterize the identified subset of primitives based on the intermediate geometry data.

19. The non-transitory computer readable medium of claim 17, wherein:
the intermediate data for the identified subset of primitives comprises assembled primitive data for the identified subset of primitives; and
the shader engine is configured to generate the attribute data values based on the assembled primitive data.

20. The non-transitory computer readable medium of claim 16, wherein to rasterize the identified subset of primitives comprises generating a rasterized subset of primitives, and wherein the set of executable instructions manipulate the at least one processor to render the scene by generating pixel data based on the rasterized subset of primitives.
